(19) United States
(12) Patent Application Publication
(10) Pub. No.: US 2021/0065577 A1
(43) Pub. Date: Mar. 4, 2021

(54) PROGRAMMATIC DEVICE STATUS DETERMINATION AND EXTENDED REALITY TROUBLESHOOTING

(71) Applicant: T-Mobile USA, Inc., Bellevue, WA (US)

(72) Inventor: Ali Daniali, Lynnwood, WA (US)

(21) Appl. No.: 16/557,677

(22) Filed: Aug. 30, 2019

(51) Int. Cl. G09B 19/00; G06N 20/00; G06F 3/14; G06T 7/00; G06T 7/90; G08B 5/38; G08B 21/18; G09B 5/02

(52) U.S. Cl. CPC G09B 19/003; G06N 20/00; G06F 3/14; G09B 5/02; G06T 7/90; G08B 5/38; G08B 21/18; G06T 7/0002

(57) ABSTRACT

Techniques are described herein for detecting light emitting indicators on a device and determining the status of the device using cameras and/or extended reality (XR) capable user devices equipped with image/video capture components. The techniques include receiving content depicting one or more device status lights of a device, the one or more device status lights indicating a device status of the device. Upon receiving the video depicting one or more device status lights, one or more features of the one or more device status lights are detected to determine the device status of the device based at least on a combination of the one or more features. Thereafter, at least one course of action is identified to mitigate identified issues based at least on the device status of the device and the device status and the at least one course of action are provided for presentation.

### BACKGROUND

Many devices incorporate status lights that may comprise light-emitting diodes (LED) to convey conditions of status and/or the health of the attached device. The lights are integrated into different locations within a device or grouped in one location of a device such as the front exterior panel. These LEDs convey information separately or as a group depending on the configuration and condition of the device.

Electroluminescence of the individual LEDs may vary by color, luminous intensity, strength/opacity, power state, flashing pattern, and/or frequency of the flicker (e.g., visibility pulse speed). The combination of all these LED variations and combinations translate to different device states/conditions. While device manuals or reference guides may describe each of the hardware components and the meaning of the indicators, it can be difficult and impracticable to visually decipher the indicator lights to diagnose problems with the device in a quick and accurate manner.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates example network architecture for determining a device status using low latency edge compute and network connectivity.

FIG. 2 is a block diagram showing various components of an illustrative computing device that programmatically determines the device status of the device using machine learning (ML) and computer vision model artifacts.

FIG. 3 is a flow diagram of an example process for determining the device status of the device using ML and computer vision model artifacts.

FIG. 4 is a flow diagram of an example process for determining the device status of the device and providing troubleshooting using an augmented reality (AR)/virtual reality (VR)/mixed reality (MR), or collectively, an extended reality (XR) capable user device.

### DETAILED DESCRIPTION

This disclosure is directed to techniques for detecting light emitting indicators on a device and determining the status of the device to report back to a troubleshooting module using cameras and/or XR capable user devices equipped with image/video capture components. For the sake of clarify, a pseudo-acronym XR has been defined to represent a plurality of different modes that users may experience virtual reality. As described above, XR modes may include AR, VR, and MR mode. Thus, XR capable user devices comprise devices that can provide AR/VR/MR applications. The individual lights may correspond to one or more hardware components of the device such as a communication interface or a battery. In this way, the individual lights may indicate the status of a specific component of the device. For example, a green-colored light corresponding to the device's battery may indicate that the battery power is fully charged. Additionally, or alternatively, the combination of the lights may indicate the overall status of the device. The overall status of the device may depend on the status of the individual hardware components of the device. For example, a combination of red and yellow-colored lights may indicate that the device is malfunctioning, wherein the individual lights may emit a single or multiple colored lights.

One or more images or a video feed of light output from the device may be provided to light analysis services, which may reside at least partially in the user devices or other computing devices. The light analysis services may be configured to determine the status of the device based at least on the light output of the device, whereby the device itself need not be connected to a network for communicating with a remote computing device to be diagnosed. In some aspects, the light analysis services may implement computer vision techniques to identify one or more predefined features of the light output and incorporate an ML pipeline to produce trained models that can be used to determine the device status. In some aspects, a low latency edge device may be used to provide on-demand ML.

Additionally, the light analysis services may, upon determining the device status, perform decision making, troubleshooting, and/or reporting operations. In the case where an XR capable user device such as an XR headset is used, instructions comprising graphic indicia or markers may be displayed as an overlay on the image or video to assist the user in performing one or more troubleshooting functions. The techniques described herein may be implemented in a number of ways. Example implementations are provided below with reference to the following figures.

### Example Network Architecture

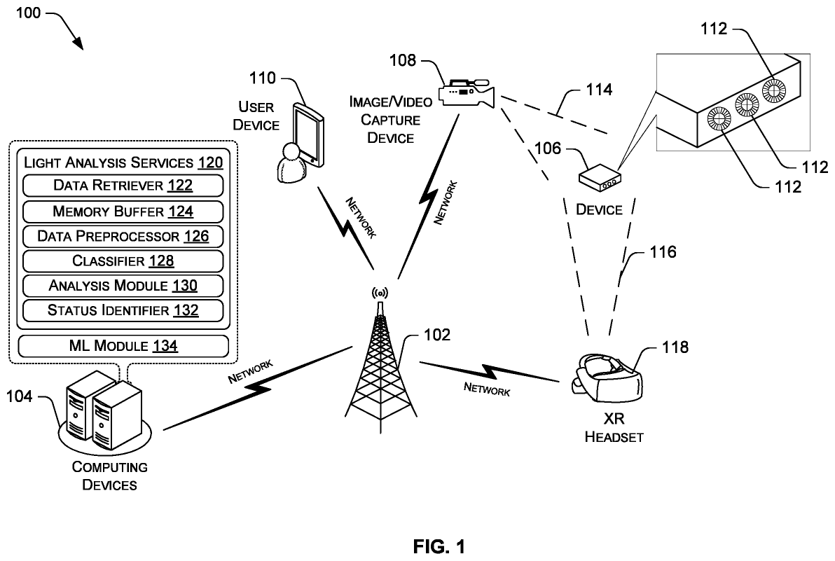

FIG. 1 illustrates example architecture for determining a device status using low latency edge compute and network connectivity. The architecture 100 may include a device 106. The device 106 is configured to output a visual indicator to inform a user of the status of the device 106. In the illustrated embodiment, the device 106 comprises one or more device status lights 112. The device 106 can comprise various types of electronic devices. Without limitations, the device 106 can comprise appliances, wearable devices, smart devices, integrated vehicle computers (e.g., carputers), and network hardware (e.g., routers, wireless access points, modems, switches, etc.). The device 106 can also comprise computing devices such as laptops, desktop computers, mobile devices, and/or other types of electronic devices with a visual output.

The device status lights 112 can comprise status LED indicators, LCD indicators, or incandescent panel indicators. The device status lights 112 can be used to indicate the device's status (e.g., health status) and to diagnose problems with the device 106. In some aspects, each of the device status lights 112 may be associated with a hardware component of the device 106. For example, a first device status light may be associated with the device's 106 power, and when the first device status light is emitting a solid light, the light indicates that the device 106 is powered on. In another example, a second device status light may be associated with the device's 106 communication interface, and the second device status light may flash when the device 106 is scanning for a network configuration server connection. A solid light can indicate that the network connection is acquired. Additionally, each of the device status lights 112 may be associated with the device's 106 activities. For example, a third device status light may flash when it is transmitting or receiving data. Further, the third device status light may flicker at different rates and/or emit different colors when it is transmitting or receiving data.

The architecture 100 further comprises an image/video capture device 108 such as a camera that is configured to capture images and/or videos of the device 106 and the device status lights 112. The device 106 is in the field of view 114 of the image/video capture device 108. The image/video capture device 108 may be stationary or mobile, depending upon embodiments. The image/video capture device 108 is configured to provide images and/or videos depicting the device status lights 112 of the device 106 to a user device 110 and/or another remote computing device (e.g., a server, an external processor, a robot, etc.) for analysis. The user device 110 comprises smartphones, mobile devices, personal digital assistants (PDAs) or other electronic devices having a wireless communication function that are capable of receiving input, processing the input, and generating output data. The user device 110 is connected to a telecommunication network utilizing one or more wireless base stations 102 or any other common wireless or wireline network access technologies. The user device 110 may comprise a data management layer that includes software utilities for facilitating the acquisition, processing, storing, reporting, and analysis of images and/or videos and related data from the remote image/video capture device 108.

In various embodiments, the user device 110 may be equipped with a camera and may directly capture images and/or videos depicting the device status lights 112. In some aspects, the user device 110 may be XR capable to overlay a marker (e.g., a pin, an anchor, etc.) or a graphical indicia on the images and/or videos for presentation. For example, the user device 110 may display, via a user interface such as a screen, a superimposed computer-generated image and/or text (e.g., a graphical indicia or a marker) on a given user's view of the user's real geographic environment that includes the device 106 in order to provide a composite view of the device 106 and the superimposed computer-generated image and/or text. The superimposed computer-generated image and/or text can provide information about the device 106 such as the status of the device 106 and troubleshooting information. Additionally, the architecture 100 may include an XR headset 118, which may be configured to capture an image and/or a video of the device 106 in its field of view 116. The XR headset 118 is further configured to render, on a display of the XR headset 118, a marker or a graphical indicia on the images and/or videos depicting the device 106.

The image/video capture device 108, the user device 110, and the XR headset 118 may be in connection with a network to facilitate communications with light analysis services 120. For example, the network 100 can implement 2G, 3G, 4G, 5G, long-term evolution (LTE), LTE advanced, high-speed data packet access (HSDPA), evolved high-speed packet access (HSPA+), universal mobile telecommunication system (UMTS), code-division multiple access (CDMA), global system for mobile communications (GSM), a local area network (LAN), a wide area network (WAN), and/or a collection of networks (e.g., the Internet).

The light analysis services 120 may reside at least partially in one or more computing devices 104. In some aspects, the light analysis services 120 may also reside at least partially in one or more user devices 110 and XR headset 118. The computing devices 104 may include general-purpose computers, such as desktop computers, tablet computers, laptop computers, servers (e.g., on-premise servers), or other electronic devices that are capable of receiving input, processing the input, and generating output data. The computing devices 104 may store data in a distributed storage system, in which data may be stored for long periods and replicated to guarantee reliability.

Accordingly, the computing devices 104 may provide data and processing redundancy, in which data processing and data storage may be scaled in response to demand. Further, in a networked deployment, new computing devices 104 may be added. Thus, the computing devices 104 can include a plurality of physical machines that may be grouped and presented as a single computing system. Each physical machine of the plurality of physical machines may comprise a node in a cluster. The computing devices 104 may also be in the form of virtual machines, such as virtual engines (VE) and virtual private servers (VPS). In some embodiments, the computing devices 104 are operatively connected to at least one data store, wherein the data store can comprise a database and/or other data sources.

The light analysis services 120 includes a data retriever 122, a memory buffer 124, a data preprocessor 126, a classifier 128, a feature analyzer 130, and a status identifier 132. In some aspects, the light analysis services 120 may implement a machine learning module 134 residing at least partially in the computing devices 104. The data retriever 122 is configured to receive captured images and/or videos (i.e., multimedia content) from the image/video capture device 108, the user device 110, the XR headset 118, and/or other data sources. The data retriever 122 may place one or more images or videos in the memory buffer 124 where additional light analysis services (e.g., data preprocessing, classification, analysis, status identification, etc.) may be applied.

The data preprocessor 126 may contain logic to remove content with insufficient information or low-quality images and/or videos from the workflow. In this way, data collected during the subsequent analysis will not contain data from corrupt or misleading content. This cleaning logic may be part of the image preprocessor 126 or alternatively may be in a separate content cleaning software component.

The classifier 128 is configured to identify which portions of an image and/or a video represent the device status lights 112 to be analyzed as opposed to portions of the image representing objects other than the device status lights 112 to be analyzed. The classifier 128 may identify discrete objects within the received image and classify those objects (i.e., device status lights 112) by size and image values, either separately or in combination.

The images and/or videos of the device 106 are provided to the feature analyzer 130. The feature analyzer 130 identifies the device 106 itself (e.g., model, brand, product type, etc.) and one or more features associated with the individual device status lights 112. The features may include color, light intensity, flashing pattern, and/or frequency of a flicker of the device status lights 112. The device 106 may also comprise a marker, text, symbol, and/or a computer-readable code such as a QR code or a bar code that can be used to identify the device 106 via the feature analyzer 130. The objects identified via the classifier 128 may be subjected to analysis of visual information by the feature analyzer 130.

In some aspects, the device 106 may comprise a virtual marker that visually overlays a real-world or virtual world object within an XR environment. The marker may be displayed to a user in the XR environment that may show content to the user in relation to a real-world or virtual world object. In various embodiments, the content can include the identity of the device. In some aspects, a marker can be associated with rules for determining the marker's behavior. For example, the marker may display specific content to a user in the XR environment when activated.

Additionally, the status identifier 132 determines the status of the device 106 based at least on the identified features of the device status lights 112. The individual features and/or a combination of the individual features may correspond to a status of the device 106. In various embodiments, the status identifier 132 may refer to a lookup table. The lookup table may be created and maintained by an original equipment manufacturer (OEM) of the device 106. The lookup table holds the association between the features and the status of the device 106. For example, a solid green device status light 112 may indicate that the device 106 is functioning normally. In another example, a fast flashing red-colored device status light 112 may indicate that a fault is detected. If there are no device status lights 112 on, no power is being applied to the device 106.

In some aspects, the status identifier 132 may determine the status of individual hardware components of the device 106 based at least on the individual and/or a combination of the individual features of the device status lights 112. For instance, a green-colored device status light 112 corresponding to the device's battery may indicate that the battery power is fully charged. In another example, red and orange device status lights 112 flashing in an alternating fashion may indicate damaged hardware.

Additionally, the lookup table may hold the association between the status of the device and issues or faults in the device's system. Based on the associations between the individual features and/or a combination of the individual features and the device status, therefore, the status identifier 132 can also identify issues or faults in the device. If the status identifier 132 identifies an issue associated with the device 106 based at least on the analysis of the device status lights 112, the status identifier 132 may also retrieve corresponding recommended courses of action to remediate the identified issue. The status identifier 132 may also provide a reporting function to present status updates or reports to a user. In the illustrated embodiment, status updates may be transmitted to the user device 110. The user device 110 may have an access to an application (e.g., an XR application) that displays the status updates of the device 106.

### Example Computing Device Components

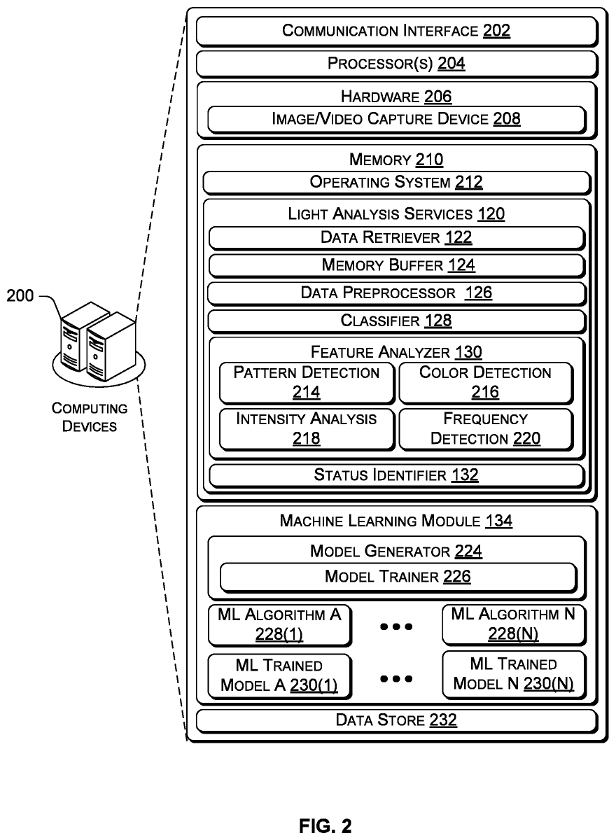

FIG. 2 is a block diagram showing various components of illustrative computing devices 200, wherein the computing devices 200 can provide light analysis services 120. It is noted that the computing devices 200 as described herein can operate with more or fewer of the components shown herein. Additionally, the computing devices 200 as shown herein or portions thereof can serve as a representation of one or more of the computing devices of the present system.

The computing devices 200 may include a communication interface 202, one or more processors 204, hardware 206, and memory 210. The communication interface 202 may include wireless and/or wired communication components that enable the computing devices 200 to transmit data to and receive data from other networked devices. In at least one example, the one or more processor(s) 204 may be a central processing unit(s) (CPU), graphics processing unit(s) (GPU), both a CPU and GPU or any other sort of processing unit(s). Each of the one or more processor(s) 204 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 204 may also be responsible for executing all computer applications stored in the memory, which can be associated with common types of volatile (RAM) and/or nonvolatile (ROM) memory. The hardware 206 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices. In some aspects, the hardware 206 comprises image/video capture device 208. In this way, the computing devices 200 may capture images and/or videos of one or more device status lights and provide light analysis services.

The memory 210 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 210 may also include a firewall. In some embodiments, the firewall may be implemented as hardware 206 in the computing devices 200.

The processors 204 and the memory 210 of the computing devices 200 may implement an operating system 212, light analysis services 120, the machine learning module 222, and a data store 232. The operating system 212 may include components that enable the computing devices 200 to receive and transmit data via various interfaces (e.g., user controls, communication interface, and/or memory input/output devices), as well as process data using the processors 204 to generate output. The operating system 212 may include a presentation component that presents the output (e.g., display the data on an electronic display, store the data in memory, transmit the data to another electronic device, etc.). Additionally, the operating system 212 may include other components that perform various additional functions generally associated with an operating system.

The data store 232 can comprise a data management layer that includes software utilities for facilitating the acquisition, processing, storing, reporting, and analysis of data from multiple data sources such as a remote image/video capture device, user devices, and/or so forth. In various embodiments, the data store 232 can interface with an API for providing data access.

The light analysis services 120 provide a data retriever 122, a memory buffer 124, a data preprocessor 126, a classifier 128, a feature analyzer 130, and a status identifier 132. The data retriever 122 is configured to receive content (e.g., captured images and/or videos) and/or related information from a remote image/video capture device, a user device, an XR headset, and/or other data or content sources. The data retriever 122 may place one or more images or videos in the memory buffer 124 or a queue where additional light analysis services (e.g., data preprocessing, classification, analysis, status identification, etc.) may be applied.

The data preprocessor 126 receives content (e.g., images and/or videos) from the data retriever 122 and/or the memory buffer 124 to scan for images and/or videos with insufficient information or low-quality images and/or videos. The images and/or videos that contain insufficient information or that do not depict device status lights clearly are removed from the workflow. For example, the data preprocessor 126 may remove images and/or videos that include obstructed views of the device status lights on a device. In this way, data collected during the subsequent analysis will not contain data from corrupt or misleading images and/or videos. This cleaning logic may be part of the image preprocessor 126 or alternatively may be in a separate image/video cleaning software component.

The classifier 128 is configured to identify which portions of an image and/or a video represent the device status lights to be analyzed as opposed to portions of the image representing objects other than the device status lights to be analyzed. The classifier 128 may identify discrete objects within the received image and classifies those objects (i.e., device status lights) by size and image values, either separately or in combination. Example image values include inertia ratio, contour area, and Red-Green-Blue (RGB) components. Based on those values, the objects are ranked and sorted. Objects above a predetermined threshold or the highest N objects are selected as portions of the received image representing device status lights.

The content is provided to the feature analyzer 130. The feature analyzer 130 identifies one or more features associated with the individual device status lights. In the illustrated embodiment, the feature analyzer 130 provides pattern detection 214 for detecting a flashing pattern of device status lights, color detection 216 for detecting color, intensity analysis 218 for determining light intensity, and frequency detection 220 for determining the frequency of a flicker. The objects identified via the classifier 128 may be subjected to analysis of visual information by the feature analyzer 130.

The pattern detection 214 may utilize various algorithms for locating and extracting well-looping segments of the captured videos depicting device status lights. In this regard, the pattern detection 214 may identify the first video frame and the last video frame that are similar. The first video frame and the last video frame are considered similar when the difference between the two frames as the sum of the differences between their color values of the frames' pixels is below a predetermined threshold or parameter. Based on the extracted segments, the pattern detection 214 may discover a pattern of flickering lights that is associated with the status of a device. Additionally, the frequency detection 220 may, based on the extracted segments, measure a device status light's flicker index, flicker percentage, and frequency values. The frequency detection 220 may detect a frequency greater than 50 Hertz, which may not be detectable to a human eye, thereby allowing for a more accurate analysis of the device status lights.

In some aspects, the color detection 216 may utilize a K-Means clustering algorithm or other ML or non-ML algorithms to form clusters of colors within the captured images and/or videos and extract those colors for analysis. Additionally, the color detection 216 may identify color differences between individual device status lights based on a distance (e.g., Euclidean distance) within a color space. If the distance within the color space is below a predetermined threshold, the color detection 216 may identify one color. The color detection 216 may cluster pixels of the images and/or videos in groups where the pairwise distance is below the predetermined threshold. Because the RGB value of each pixel is substantially proportional to the luminance of the corresponding device status light, the intensity analysis 218 may be configured to quantify light intensity (i.e., illuminance and luminous emittance) of device status lights from captured images and/or videos. In some aspects, the intensity analysis 218 may receive measurements (e.g., luminous flux per unit area) from a detector or a sensor such as a photometer.

Additionally, the status identifier 132 determines the status of the device 106 based at least on the identified features of the device status lights for the particular device 106. In this way, the status identifier 132 may determine different statuses for different devices given a set of one or more features. The individual features and/or a combination of the individual features may correspond to a status of the device 106. For example, a solid green device status light may indicate that the device 106 is functioning normally. In another example, a fast flashing red-colored device status light may indicate that a fault is detected. If there are no device status lights on, no power is being applied to the device 106. In some aspects, the status identifier 132 may determine the status of individual hardware components of the device 106 based at least on the individual and/or a combination of the individual features of the device status lights. For instance, a green-colored device status light corresponding to the device's battery may indicate that the battery power is fully charged. In another example, red and orange device status lights flashing in an alternating fashion may indicate damaged hardware.

In some aspects, the status identifier 132 may discover a combination of features that indicate a certain issue with a device. If the status identifier 132 identifies one or more issues associated with the device 106 based at least on the analysis of the device status lights, the status identifier 132 may also retrieve, from a solutions database, corresponding recommended courses of action to remediate the identified issue. The status identifier 132 may also provide a reporting function to provide status updates or status reports for presentation by an application on a user device. In the illustrated embodiment, status updates may be transmitted to the user device.

In various embodiments, the techniques include programmatically determining the condition of the device using ML and computer vision model artifacts, which can increase the efficiency of the process for recording, learning and processing the LED information without requiring the device being monitored or diagnosed to be directly connected to a network. For instance, the feature analyzer 130 and the status identifier 132 of the light analysis services 120 may utilize the machine learning module 222 to analyze the device status lights to determine a device's status and whether the device is functioning normally. The machine learning module 222 may be a component of an ML training pipeline, depending upon embodiments. The machine learning module 222 includes a model generator 224 that may include a model trainer 226 for training ML models by applying one or more ML algorithms 228(1)-228(N) to a training dataset. The ML algorithms 228(1)-228(N), which may include a Bayesian algorithm, a decision tree algorithm, a Support Vector Machine (SVM) algorithm, and/or so forth. The training dataset can emulate data (e.g., images, videos) collected from data sources such as cameras, user devices, and/or XR headsets. The training dataset can also include a set of desired outputs for the training dataset. The model trainer 226 of the model generator 224 may be configured to perform data quality assurance analysis to identify outlier data, redundant data, irrelevant data, and/or so forth.

Once an ML algorithm 228(1)-228(N) is applied, the model trainer 226 may determine whether a training error measurement of the ML trained model is above a predetermined threshold. The training error measurement may indicate the accuracy of the ML model in identifying features of device status lights and/or determining device status. If the training error measurement exceeds the predetermined threshold, another ML algorithm is selected, for example, via a rules engine (e.g., algorithm selection rules) based on a magnitude of the training error measurement. More particularly, the algorithm selection rules may be used by a rules engine of the model training module to match specific ranges of training error measurement value to a specific type of ML algorithm. After the second ML algorithm is applied, the training error is measured again and this process repeats until the training error is below the predetermined threshold. The ML trained model 230(1)-230(N) can be augmented as needed by adding additional training data sets and/or training results from one or more ML algorithm based on feedback regarding the accuracy of the feature detection and device status identification.

In various embodiments, the light analysis services 120 may also implement non-ML techniques such as decision tree learning, association rule learning, artificial neural networks, inductive logic, Support Vector Machines (SVMs), clustering, Bayesian networks, reinforcement learning, representation learning, similarity and metric learning, and sparse dictionary learning to extract any patterns.

### Example Processes

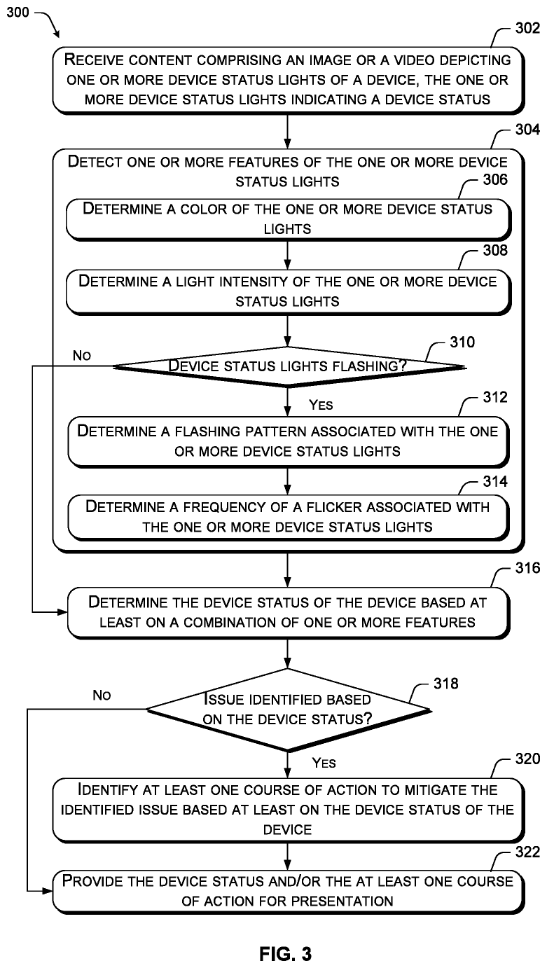

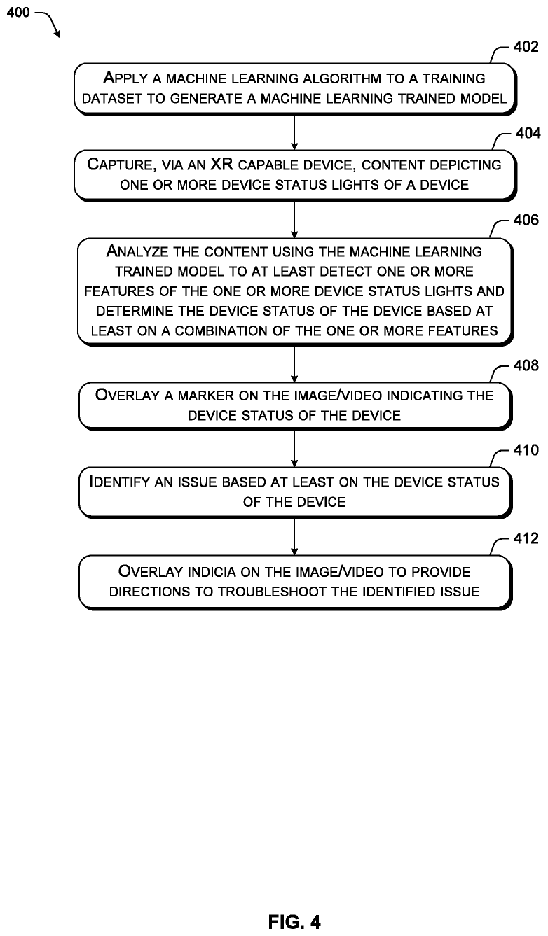

FIGS. 3 and 4 present illustrative processes 300-400 for determining the device status of the device based at least on one or more device status lights. The processes 300-400 are illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 300-400 are described with references to FIGS. 1 and 2.

FIG. 3 is a flow diagram of an example process 300 for determining the device status of the device using ML and computer vision model artifacts from the perspective of a computing device that provides light analysis services. At block 302, the computing device receives, via a data retriever of the light analysis services, content comprising an image or a video depicting one or more device status lights of a device, the one or more device status lights indicating a device status of the device. The data retriever may place the image or the video in a memory buffer or a queue where additional light analysis services (e.g., data preprocessing, classification, etc.) may be applied. At block 304, the computing device detects, via a feature analyzer of the light analysis services, one or more features of the one or more device status lights. The step of detecting one or more features of the one or more device status lights includes determining, via a color detection module, a color of the one or more status lights, as indicated in block 306. At block 308, the computing device determines, via an intensity analysis module, a light intensity of the one or more device status lights. At decision block 310, the computing device determines, via the feature analyzer, whether the device status lights are flashing. If the device status lights are flashing (“yes” from the block 310), the computing device determines, via a pattern detection module, a flashing pattern associated with the one or more device status lights, as indicated in block 312. At block 314, the computing devices determine, via a frequency detection, a frequency of the flicker associated with the one or more device status lights.

If the device status lights are not flashing (“no” from the decision block 310) based at least on the image or the video, the computing device determines, via a status identifier of the light analysis services, the device status of the device based at least on the combination of one or more features of the one or more device status lights, as indicated in block 316. At decision block 318, the computing device determines, via the status identifier, whether an issue is identified based on the device status. If issues are identified based on the device status (“yes” from the decision block 318), the computing devices identifies, via the status identifier, at least one course of action to mitigate the identified issue based at least on the device status of the device, as indicated in block 320. If no issues are identified based on the device status (“no” from the decision block 318), the computing device provides, via the status identifier, the device status and/or the course of action to a user device for presentation, as indicated in block 322.

FIG. 4 is a flow diagram of an example process for determining the device status of the device and providing troubleshooting using an XR capable user device. For example, the XR capable user device may be a combination of wearable devices such as AR/VR glasses, smartphone augmented reality (mobile AR), tethered AR head-mounted display (HMD), and/or so forth. In some aspects, the XR capable user device may provide light analysis services. The XR capable user device may comprise a low latency edge device that may be used to provide on-demand ML. At block 402, the XR capable device applies a machine-learning algorithm to a training dataset to generate an ML trained model. At block 404, the XR capable device captures content (e.g., an image or a video) depicting one or more device status lights of a device. The XR capable device may be configured to transmit captured content to a remote computing device for additional light analysis services, depending upon embodiments.

At block 406, the XR capable device analyzes the content using the ML trained model to at least detect one or more features of the one or more device status lights and determine the device status of the device based at least on a combination of the one or more features. The features include light color, light intensive, flashing pattern, and frequency of the one or more device status lights. At block 408, the XR capable device overlays a marker (e.g., a computer-generated image) on the image or the video indicating the device status of the device. At block 410, the XR capable device identifies, via the status identifier, an issue based at least on the device status of the device. At block 412, the XR capable device overlays a graphical indicia on the image and/or the video to provide directions to troubleshoot issues identified.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. One or more non-transitory computer-readable media storing computer-executable instructions that upon execution cause one or more processors to perform acts comprising:
receiving content depicting one or more device status lights of a device, the one or more device status lights indicating a device status of the device;
detecting one or more features of the one or more device status lights depicted in the content;
applying a machine-learning algorithm to a training dataset to generate a machine-learning trained model, wherein the training dataset comprises one or more combinations of the one or more features;
analyzing the one or more features of the one or more device status lights depicted in the content using the machine-learning trained model to identify a combination of the one or more features that is associated with an issue;
determining the device status of the device based at least on the combination of the one or more features detected from the content; and
providing the device status for presentation.

2. (canceled)

3. The one or more non-transitory computer-readable media of claim 1, wherein the one or more features include a color of the one or more device status lights, a light intensity of the one or more device status lights, a flashing pattern associated with the one or more device status lights, and a frequency of a flicker associated with the one or more device status lights.

4. The one or more non-transitory computer-readable media of claim 1, wherein the device status is provided to an extended reality capable device.

5. The one or more non-transitory computer-readable media of claim 1, wherein the acts further comprise:
identifying at least one course of action to mitigate the issue based at least on the device status of the device; and
providing the at least one course of action for presentation.

6. The one or more non-transitory computer-readable media of claim 1, wherein the acts further comprise:
displaying a marker on an image or a video of the content indicating the device status of the device.

7. The one or more non-transitory computer-readable media of claim 1, wherein the acts further comprise:
displaying an indicia on an image or a video of the content to provide directions to troubleshoot the issue based at least on the device status of the device.

8. A computer-implemented method, comprising:
receiving content depicting one or more device status lights of a device, the one or more device status lights indicating a device status of the device;
detecting one or more features of the one or more device status lights depicted in the content;
applying a machine-learning algorithm to a training dataset to generate a machine-learning trained model, wherein the training dataset comprises one or more combinations of the one or more features;
analyzing the one or more features of the one or more device status lights depicted in the content using the machine-learning trained model to identify a combination of the one or more features that is associated with an issue;
determining the device status of the device based at least on the combination of the one or more features detected from the content; and
providing the device status for presentation.

9. (canceled)

10. The computer-implemented method of claim 8, wherein the one or more features include a color of the one or more device status lights, a light intensity of the one or more device status lights, a flashing pattern associated with the one or more device status lights, and a frequency of a flicker associated with the one or more device status lights.

11. The computer-implemented method of claim 8, wherein the individual device status lights correspond to a hardware component of the device.

12. The computer-implemented method of claim 11, wherein the device is disconnected from a telecommunication network.

13. The computer-implemented method of claim 12, further comprising:
rendering on a display of an extended reality device, a marker on an image or a video of the content indicating the device status of the device.

14. The computer-implemented method of claim 12, further comprising:
rendering on a display of an extended reality device, an indicia on an image or a video of the content to provide directions to troubleshoot the issue based at least on the device status of the device.

15. A system, comprising:
one or more non-transitory storage mediums configured to provide stored computer-readable instructions, the one or more non-transitory storage mediums coupled to one or more processors, the one or more processors configured to execute the computer-readable instructions to cause the one or more processors to:
receive content depicting one or more device status lights of a device, the one or more device status lights indicating a device status of the device;
detect one or more features of the one or more device status lights depicted in the content;
apply a machine-learning algorithm to a training dataset to generate a machine-learning trained model, wherein the training dataset comprises one or more combinations of the one or more features;
analyze the one or more features of the one or more device status lights depicted in the content using the machine-learning trained model to identify a combination of the one or more features that is associated with an issue;
determine the device status of the device based at least on the combination of the one or more features detected from the content; and
provide the device status for presentation.

16. (canceled)

17. The system of claim 15, wherein the one or more features include a color of the one or more device status lights, a light intensity of the one or more device status lights, a flashing pattern associated with the one or more device status lights, and a frequency of a flicker associated with the one or more device status lights.

18. The system of claim 15, wherein the individual device status lights correspond to a hardware component of the device.

19. The system of claim 18, wherein the one or more processors are further configured to:
determine a hardware component status of the device based at least on a combination of the one or more features of the individual device status lights; and
determine the device status based at least on the hardware component status.

20. The system of claim 15, wherein the one or more processors are further configured to:
provide the device status to an extended reality device; and
render, on a display of the extended reality device, a marker on an image or a video of the content indicating the device status of the device and an indicia on the image or the video to provide directions to troubleshoot the issue based at least on the device status of the device.

21. The one or more non-transitory computer-readable media of claim 1, wherein the acts further comprise:
recognizing a device identifier on the device; and
identifying the device based at least on the marker.

22. The one or more non-transitory computer-readable media of claim 21, wherein the device identifier comprises at least one of a marker, text, symbol, and a computer-readable code indicating an identity of the device.

23. The one or more non-transitory computer-readable media of claim 22, wherein the one or more features are based at least on the identity of the device.
